(19) United States
(12) Patent Application Publication
(10) Pub. No.: US 2022/0010167 A1
(43) Pub. Date: Jan. 13, 2022

(54) AQUEOUS PRIMER COATING

(71) Applicant: Covestro Intellectual Property GmbH & Co. KG, Leverkusen (DE)

(72) Inventors: Thomas Michaelis, Leverkusen (DE); Torsten Pohl, Leverkusen (DE); Sven Siegemund, Burscheid (DE); Jan Weikard, Leverkusen (DE)

(21) Appl. No.: 17/295,500

(22) PCT Filed: Dec. 17, 2019
(86) PCT No.: PCT/EP2019/085640

§ 371 Date: May 20, 2021

(30) Foreign Application Priority Data
Dec. 18, 2018 (EP) 18213389.2

(51) Int. Cl. C09D 175/06; C09D 109/06; C09D 5/00; C08G 18/08; C08G 18/12; C08G 18/44; C08G 18/42; C08G 18/73; C08K 3/04; C08K 5/00; B05D 7/00

(52) U.S. Cl. CPC C09D 175/06; B05D 2401/20; C09D 5/002; C08G 18/0823; C08G 18/12; C08G 18/44; C08G 18/4208; C08G 18/73; C08K 3/04; C08K 5/0025; B05D 7/50; C08K 2201/001; B05D 2201/02; B05D 2420/01; C09D 109/06

(57) ABSTRACT

The present invention relates to novel coatings which are applied from an aqueous phase to substrates such as plastics, and which are overlaid with other coatings. These coatings are characterized by particularly good adhesive strength, in particular on plastics, and are thus particularly commercial.

The present invention relates to novel coatings which are applied to substrates such as plastics from an aqueous phase and are covered with further coatings. These coatings display particularly good adhesive strengths, in particular on plastics, and are thus particularly economically advantageous.

If surface coatings on plastic parts also have to satisfy, for example, requirements such as good adhesive strength even after weathering, for example as in automobile construction, the plastic parts are usually coated with a primer before the color-imparting and effect-producing topcoat layer or layers are applied. Apart from adhesive strength, the primer should also contribute to protection against impact of stones. Furthermore, a primer can be made conductive by addition of appropriate additives such as conductive carbon blacks, so that the subsequently applied layers can be applied by means of electrostatic spray application and thus with particularly high transfer efficiency.

To avoid solvent emissions, aqueous primers, which are usually based on polyurethane dispersions (PUD) as binder, are also being offered today. Hydrolysis-stable PUDs are comparatively expensive binders, so that there is a need for a cheaper binder system which satisfies the requirement profile for a primer on plastic parts. EP-B 1226218 describes hydro primer formulations based on polyurethane dispersions as are used at present on a large scale for coating automobile components.

The technical datasheet of Synthomer Deutschland GmbH for Litex® N 7100 (Technical Data Sheet, Revision: 4, October 30, 2014) describes possible mixing with polyurethanes for a styrene-polybutadiene copolymer latex “Litex N 7100 is used for leather finishing formulations. The latex is compatible with the common additives used for leather finishing including crosslinking agents like zinc oxide. Blending of Litex N 7100 with all-acrylics or polyurethanes is also possible.”

The patent applications US2013186546, EP2181826, DE19609311, EP0167189, U.S. Pat. No. 3,922,470 explicitly and/or generically disclose compositions which contain polyurethane dispersions (PUD) or styrene-polybutadiene copolymer dispersions (SBR) and are employed in the leather and textile industry.

Use for coating of plastics, for example in the field of aqueous primers for coating thermoplastics from an injection molding process and in particular as blends with polyurethane dispersions is not mentioned.

It was an object of the invention to at least partly minimize at least one disadvantage of the prior art. Furthermore, it was an object of the invention to indicate an inexpensive and simple possible way of providing a binder having the positive properties of a polyurethane dispersion for coating thermoplastics.

At least one of these objects has been able to be achieved in the context of the present invention by a composition containing an aqueous polyurethane dispersion (PUD) which contains a certain amount of styrene-polybutadiene copolymer dispersion (SBR).

The invention therefore firstly provides a composition for coating substrates, in particular for coating thermoplastic substrates, containing at least one optionally hydroxy-functional, anionic or nonionic polyurethane dispersion (PUD) and at least one anionic styrene-polybutadiene copolymer dispersion (SBR).

In a preferred embodiment of the composition, the weight ratio of the PUD to the SBR in the composition is in a range from 10:1 to 1:3, preferably in a range from 9:1 to 1:2, based on the nonvolatile proportion of the composition. The nonvolatile proportion is determined by evaporation of the solvents or dispersion media and treatment of 1 g of the composition for 1 hour at 125° C. in accordance with DIN EN ISO 32511.

In a preferred embodiment of the composition, the composition comprises the PUDs in a proportion of from 33 to 90% by weight, preferably from 45 to 85% by weight, particularly preferably from 60 to 80% by weight, based on the nonvolatile proportion of the composition.

In a preferred embodiment of the composition, the composition comprises the SBRs in a proportion of from 10 to 67% by weight, preferably from 15 to 55% by weight, particularly preferably from 20 to 40% by weight, based on the nonvolatile proportion of the composition.

The composition preferably has a solids content in a range from 20 to 60% by weight, preferably from 30 to 55% by weight, based on the total mass of the composition. The solids content and also the abovementioned nonvolatile proportion of the composition is the proportion of the composition which is obtained after evaporation of the solvents or dispersion media and treatment of 1 g of the composition for 1 hour at 125° C. in accordance with DIN EN ISO 32511.

In a preferred embodiment of the coating composition, the composition contains at least one reactive crosslinker component, in particular a polyisocyanate. The coating composition preferably comprises the reactive crosslinker component in an amount of from 0.01 to 5% by weight, more preferably from 0.1 to 4% by weight, particularly preferably from 0.3 to 3% by weight, based on the total mass of the composition.

For the purposes of the present invention, hydroxy-functional, anionic and/or nonionic polyurethane dispersions (PUD) are the following dispersions: commercially available PUDs are, for example, products of Covestro AG, Leverkusen, DE, which are marketed under the tradenames Bayhydrol® UH, U and UA, Impranil®, Baybond® and Dispercoll® U, products of Alberdingk-Boley GmbH, Krefeld, DE, which are marketed under the tradename Alberdingk® U, products of DSM NeoResins, Zwolle, N L, which are marketed under the tradename NeoCryl® R, products of Allnex by, Drogenbos, B E, which are marketed under the tradename Daotan®, products of Lubrizol Ltd, UK, which are marketed under the tradename Sancure®, products of Wanhua Chemical Group Ltd. CN, which are marketed under the tradename Lacper® PUD or PUA.

These and other aqueous polyurethane dispersions contain at least one polymer selected from the group consisting of at least one polyurethane or at least one polyurethane-polyurea or mixtures of at least two thereof. In the following, no distinction will be made between polyurethane and polyurethane-polyurea for the polymer present in the polyurethane dispersion but instead only the term polyurethane will be used, with the polyurethane also being able to be a polyurethane-polyurea. In order to keep the polymers in a stable dispersion in water, use is usually made of internal, i.e. chemically bound polymers, or external emulsifiers or mixtures of internal and external emulsifiers. Preference is given to using internal emulsifiers for stabilization. The internal emulsifiers are preferably nonionic, anionic or cationic groups. Anionic and nonionic emulsifiers and mixtures of these two emulsifiers are preferred. Particular preference is given to polymers which are hydrophilized only with internal anionic emulsifiers.

To produce the PUD, it is possible to use all methods known from the prior art, for example emulsifiers shear force, acetone, prepolymer mixing, melt emulsification, ketimine and solid spontaneous dispersion processes or derivatives thereof. A summary of these methods may be found in Methoden der Organischen Chemie, Houben-Weyl, ^{4th} edition, volume E20/part 2 on page 1682, Georg Thieme Verlag, Stuttgart, 1987. The melt emulsification process and the acetone process are preferred. Particular preference is given to the acetone process.

The at least one polyurethane present in the polyurethane dispersion PUD is obtainable from the reaction of at least the components:
(A) at least one polyol component,
(B) at least one polyisocyanate component,
(C) at least one hydrophilizing component having at least one hydrophilizing group,
(D) optionally mono-, di- and/or tri-amino-functional and/or hydroxyamino-functional compounds and
(E) optionally isocyanate-reactive compounds.

Suitable polyol components (A) are compounds having at least two hydrogen atoms which are reactive toward isocyanates. The polyol component (A) preferably has a number average molecular weight Mn in a range from 62 to 18 000 g/mol, particularly preferably from 62 to 4000 g/mol.

In a preferred embodiment of the composition, the polyol component (A) is selected from the group consisting of a polyether polyol, a polyester polyol, a polycarbonate polyol, a polylactone polyol and a polyamide polyol or mixtures of at least two thereof. Preferred polyols (A) preferably have from 2 to 4, particularly preferably from 2 to 3, hydroxyl groups, very particularly preferably 2 hydroxyl groups. Mixtures of various compounds of this type are also possible.

Possible polyester polyols are, in particular, linear polyester diols or weakly branched polyester polyols as can be produced in a known manner from aliphatic, cycloaliphatic or aromatic dicarboxylic or polycarboxylic acids, e.g. succinic, methylsuccinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic, cyclohexanedicarboxylic, maleic, fumaric, malonic or trimellitic acid, and acid anhydrides, e.g. o-phthalic, trimellite or succinic anhydride or mixtures of at least one of these, by reaction with polyhydric alcohols, e.g. ethanediol, diethylene, triethylene, tetraethylene glycol, 1,2-propanediol, dipropylene, tripropylene, tetrapropylene glycol, 1,3-propanediol, 1,4-butanediol, 1,3-butanediol, 2,3 -butandiol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof, optionally with concomitant use of higher-functional polyols such as trimethylolpropane, glycerol or pentaerythritol. Cycloaliphatic and/or aromatic di-hydroxyl and polyhydroxyl compounds are naturally also possible as polyhydric alcohols for producing the polyester polyols. Instead of the free polycarboxylic acids, it is also possible to use the corresponding polycarboxylic anhydrides or corresponding polycarboxylic esters of lower alcohols or mixtures of at least two thereof for producing the polyesters.

The polyester polyols can of course also be homopolymers or copolymers of lactones, which are preferably obtained by molecular addition of lactones or lactone mixtures, e.g. butyrolactone, E-caprolactone and/or methyl-ϵ-caprolactone, onto suitable difunctional and/or higher-functional starter molecules, e.g. the low molecular weight, polyhydric alcohols mentioned above as formative components for polyester polyols. The corresponding polymers of ϵ-caprolactone are preferred.

Polycarbonates having hydroxyl groups are also possible as polyol components (A), e.g. those which can be produced by reaction of diols such as 1,4-butanediol and/or 1,6-hexanediol with diaryl carbonates such as diphenyl carbonate, dialkyl carbonates such as dimethyl carbonate or phosgene or mixtures of at least two thereof. The hydrolysis resistance of the polyurethane dispersions can be improved by the at least partial use of polycarbonates having hydroxyl groups.

Suitable polyether polyols are, for example, the polyaddition products of styrene oxide, of ethylene oxide, propylene oxide, tetrahydrofuran, butylene oxide, epichlorohydrin and also coaddition and grafting products thereof, and also the polyether polyols obtained by condensation of polyhydric alcohols or mixtures of same, and obtained by alkylation of polyhydric alcohols, amines and amino alcohols. Polyether polyols suitable as formative components (A) are the homopolymers, copolymers and graft polymers of propylene oxide and of ethylene oxide which are obtainable by molecular addition of the abovementioned epoxides onto low molecular weight diols or triols as have been mentioned above as formative components for polyester polyols or onto higher-functional low molecular weight polyols such as pentaerythritol or sugars or onto water.

Components (A) which are likewise suitable are low molecular weight diols, triols and/or tetraols such as ethanediol, diethylene, triethylene, tetraethylene glycol, 1,2-propanediol, dipropylene, tripropylene, tetrapropylene glycol, 1,3-propanediol, 1,4-butanediol, 1,3 -butanediol, 2,3 -butanediol, 1,5-pentandiol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol, Neopentyl glycol, 1,4-cyclohexanediol, 1,4-cyclohexanedimethanol, 1,4-, 1,3-, 1,2-dihydroxybenzene or 2,2-bis(4-hydroxyphenyl)propane (bisphenol A), TCD diol, trimethylolpropane, glycerol, pentaerythritol, dipenthaerytritol or mixtures thereof, optionally with concomitant use of further diols or triols which have not been mentioned.

Reaction products of the abovementioned polyols, in particular the low molecular weight polyols, with ethylene oxide and/or propylene oxide can also be used as polyol component (A).

The low molecular weight components (A) preferably a number average molecular weight Mn of from 62 to 400 g/mol and are preferably used in combination with the above-described polyester polyols, polylactones, polyethers and/or polycarbonates.

The polyol component (A) is preferably present in the polyurethane of the PUD in a range of from 20 to 95% by weight, particularly preferably from 30 to 90% by weight and very particularly preferably from 65 to 90% by weight, based on the total mass of the polyurethane composition.

Suitable components (B) are any organic compounds which have at least two free isocyanate groups per molecule. The polyisocyanate component preferably has free and/or blocked isocyanate groups in a range from 2 to 6, preferably from 2 to 4, particularly preferably from 2 to 3.

As polyisocyanate component (B), preference is given to using diisocyanates Y(NCO)2, where Y is selected from the group consisting of a divalent aliphatic hydrocarbon radical having from 4 to 12 carbon atoms, a divalent cycloaliphatic hydrocarbon radical having from 6 to 15 carbon atoms, a divalent aromatic hydrocarbon radical having from 6 to 15 carbon atoms, a divalent aliphatic hydrocarbon radical having from 7 to 15 carbon atoms or a mixture of at least two of these.

In a preferred embodiment of the composition, the polyisocyanate (B) is selected from the group consisting of tetramethylene diisocyanate, pentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane (=IPDI, isophorone diisocyanate), bis(4-isocyanatocyclohexyl)methane, 2,2-bis(4-isocyanatocyclohexyl)propane, 1,4-di-isocyanatobenzene, 2,4-diisocyanatotoluene, 2,6-diisocyanatotoluene, 4,4′-diisocyanatodi-phenylmethane, 2,2′- and 2,4′-diisocyanatodiphenylmethane, tetramethylxylylene diisocyanate, p-xylylene diisocyanate, p-isopropylidene diisocyanate and also mixtures consisting of at least two of these compounds.

Apart from these simple diisocyanates, polyisocyanates which contain heteroatoms in the radical linking the isocyanate groups and/or have a functionality of more than 2 isocyanate groups per molecule are also suitable. The former are polyisocyanates which are made up of at least 2 diisocyanates and have a uretdione, isocyanurate, urethane, allophanate, biuret, carbodiimide, iminooxadiazinedione and/or oxadiazinetrione structure and are produced by, for example, modification of simple aliphatic, cycloaliphatic, araliphatic and/or aromatic diisocyanates. As an example of an unmodified polyisocyanate having more than 2 isocyanate groups per molecules, mention may be made of, for example, 4-isocyanatomethyl octane 1,8-diisocyanate (nonane triisocyanate).

Particularly preferred polyisocyanates (B) are hexamethylene diisocyanate (=HDI), pentamethylene diisocyanate, 1,4-diisocyanatocyclohexane, 1-isocyanato-3,3,5-trimethyl-5-isocyanatomethylcyclohexane (=IPDI), 4,4′-diisocyanatodicyclohexylmethane, 2,4-diisocyanatotoluene, 2,6-diisocyanatotoluene, 4,4′-diisocyanatodiphenylmethane, 2,2′- and 2,4′-diisocyanatodiphenylmethane and also mixtures consisting of at least two of these compounds.

Particularly preferred components (B) are hexamethylene diisocyanate and 1-isocyanato-3,3,5-trimethyl-5-isocyanatomethylcyclohexane.

Component (B) is present in the PUD in amounts in a range from 5 to 60% by weight, preferably from 6 to 45% by weight and particularly preferably from 7 to 25% by weight, in the polyurethane according to the invention.

In a preferred embodiment of the composition, the hydrophilizing group of the hydrophilizing component (C) is selected from the group consisting of a sulfonate group, a carboxylate group or a combination of at least two thereof. Suitable components (C) are, for example, components containing sulfonate or carboxylate groups, e g diamino compounds or dihydroxy compounds which additionally bear sulfonate and/or carboxylate groups, for example the sodium, lithium, potassium, tert-amine salts of N-(2-aminoethyl)-2-aminoethanesulfonic acid, of N-(3-aminopropyl)-2-aminoethanesulfonic acid, of N-(3-aminopropyl)-3-aminopropanesulfonic acid, of N-(2-aminoethyl)-3-aminopropanesulfonic acid, of the analogous carboxylic acids, of dimethylolpropionic acid, of dimethylolbutyric acid, of Michael addition reaction products of 1 mol of diamine such as 1,2-ethanediamine or isophoronediamine and 2 mol of acrylic acid or maleic acid and also mixtures of at least two thereof.

The acids are frequently used directly in their salt form as sulfonate or carboxylate. However, it is also possible to add part or all of the neutralizing agent required for salt formation only during or after production of the polyurethanes.

Tertiary amines which are particularly suitable and preferred for salt formation are, for example, triethylamine, dimethylcyclohexylamine, ethyldiisopropylamine. However, it is also possible to use other amines such as ammonia, diethanolamine, triethanolamine, dimethylethanolamine, methyldiethanolamine, aminomethylpropanol and mixtures of the amines mentioned and also other amines for salt formation. These amines are usefully added only after substantial reaction of the isocyanate groups.

It is also possible to use other neutralizing agents such as sodium, potassium, lithium, calcium hydroxide for neutralization purposes.

Further suitable components (C) are nonionically hydrophilizing, monofunctional or difunctional polyethers based on alcohol- or amine-initiated ethylene oxide polymers or ethylene oxide/propylene oxide copolymers, e.g. Polyether LB 25 (Covestro AG; Germany) or MPEG 750: methoxypolyethylene glycol, molecular weight 750 g/mol (e.g. Pluriol® 750, BASF AG, Germany).

Preferred components (C) are N-(2-aminoethyl)-2-aminoethanesulfonate and the salts of dimethylolpropionic acid and of dimethylolbutyric acid.

Component (C) is present in the polyurethane present in the PUD in an amount of preferably from 0.1 to 15% by weight, particularly preferably from 0.5 to 10% by weight, very particularly preferably from 0.8 to 5% by weight and even more preferably from 0.9 to 3.0% by weight, based on the total mass of the polyurethane.

In a preferred embodiment of the composition, the mono-, di- and/or tri-amino-functional and/or hydroxyamino-functional compounds (D) are selected from the group consisting of monofunctional, difunctional, trifunctional amines and/or monofunctional, difunctional, trifunctional hydroxyamines, e.g. aliphatic and/or alicyclic primary and/or secondary monoamines such as ethylamine, diethylamine, the isomeric propylamines and butylamines, higher linear aliphatic monoamines and cycloaliphatic monoamines such as cyclohexylamine. Further examples are amino alcohols, i.e. compounds which contain amino groups and hydroxyl groups in one molecule, e.g. ethanolamine, N-methylethanolamine, diethanolamine, diisopropanolamine, 1,3-diamino-2-propanol, N-(2-hydroxyethyl)ethylenediamine, N,N-bis(2-hydroxyethyl)ethylenediamine and 2-propanolamine. Further examples are diamines and triamines such as 1,2-ethanediamine, 1,6-hexamethylenediamine, 1-amino-3,3,5-trimethyl-5-aminomethylcyclohexane (isophoronediamine), piperazine, 1,4-diaminocyclohexane, bis(4-aminocyclohexyl)methane and diethylenetriamine. Furthermore, adipic dihydrazide, hydrazine and hydrazine hydrate are possible. It is of course also possible to use mixtures of a plurality of the abovementioned compounds (D), optionally also together with compounds (D) which have not been mentioned.

Preferred components (D) are 1,2-ethanediamin, 1-amino-3,3,5-trimethyl-5-aminomethyl-cyclohexan, diethylenetriamine, diethanolamine, ethanolamine, N-(2-hydroxy-ethyl)ethylenediamine and N,N-bis(2-hydroxyethyl)ethylenediamine.

Components (D) serve as chain extenders, preferably for building up higher molecular weights, or as monofunctional compounds to limit molecular weights and/or, optionally, to additionally incorporate further reactive groups such as free hydroxyl groups as further crosslinking points into the polyurethane.

Component (D) is present in the polyurethane in an amount of preferably from 0 to 10% by weight, particularly preferably from 0 to 5% by weight and very particularly preferably from 0.2 to 3% by weight, based on the total mass of the polyurethane.

The at least one other isocyanate-reactive compound (E) which is optionally to be concomitantly used is preferably an aliphatic, cycloaliphatic or aromatic monoalcohol having from 2 to 22 carbon atoms. In a preferred embodiment of the composition, the at least one other isocyanate-reactive compound (E) is selected from the group consisting of ethanol, butanol, hexanol, cyclohexanol, isobutanol, benzyl alcohol, stearyl alcohol, 2-ethylethanol, cyclohexanol; unsaturated compounds which contain groups capable of undergoing polymerization reactions, e.g. hydroxyethyl acrylate, hydroxyethyl methacrylate, hydroxybutyl acrylate, hydroxybutyl methacrylate, hydroxypropyl acrylate, hydroxypropyl methacrylate, pentaerythritol triacrylate, hydroxy-functional reaction products of monoepoxides, bisepoxides and/or polyepoxides with acrylic acid or methacrylic acid or mixtures of at least two thereof.

The component (E) is preferably present in the polyurethane in an amount of from 0 to 20% by weight, very preferably from 0 to 10% by weight, based on the total mass of the polyurethane.

The abovementioned PUDs can also be modified by addition of free-radically polymerizable vinyl monomers and graft polymers thereof in an emulsion polymerization by addition of polymerization initiators known per se. If vinyl monomers have been incorporated as component (E) into the PUD, these will preferably react as graft base in the emulsion polymerization.

In a preferred embodiment of the coating composition, polyurethane dispersions used are ones which contain, as formative components (A), either aromatic polyester components and in particular polyester diol components and as acid components phthalic acid, isophthalic acid, terephthalic acid or mixtures thereof, at least in part; preference is also given to polyurethane dispersions which contain polycarbonate diols as formative components (A) and also polyurethane dispersions which contain mixtures of aromatic polyester diols with polycarbonate diols as formative component (A). Preference is also given to mixtures of polyurethane dispersions which contain polyester components and in particular polyester diol components as formative components (A) and, as acid components, phthalic acid, isophthalic acid, terephthalic acid or mixtures thereof, at least in part, with polyurethane dispersions which contain polycarbonate diols as formative components (A).

Examples of anionic styrene-polybutadiene copolymer dispersions are: commercially available products, for example SBR, which are marketed by BASF SE, Ludwigshafen, DE under the tradenames Styrofan® and Styronal®, those marketed by AsahiKasei Chemicals, Tokyo, Jp under the name SB Latex, those marketed by Arlanxeo Deutschland GmbH, Dormagen, DE under the tradename Takene® Latex, those marketed by Synthomer

Deutschland GmbH under the tradename Liex® and those marketed by Zeon Corporation, Tokyo, Jp under the tradename Nipol®.

SBRs are essentially polystyrene dispersions which are altered, in particular plasticized, by addition of polybutadiene. They tend to have elastomeric properties rather than thermoplastic properties. The polymers are stabilized in water by addition of external emulsifiers or copolymerization of vinyl monomers bearing acid groups, e.g. acrylic or methacrylic acid. The respective proportions of polystyrene and polybutadiene influence the glass transition temperature of the polymer. At a high proportion of polystyrene, the glass transition temperature is above 23° C. through to that of pure polystyrene, while at high proportions of polybutadiene the glass transition temperature is below 23° C. and can be down to −30° C. and below.

For the coating composition of the invention, as styrene-polybutadiene copolymer dispersions used are preferably SBRs which are stabilized by carboxylate groups. Particular preference is given here to carboxylate-stabilized SBRs which have a glass transition temperature in the range from −30° C. to +50° C., in particular from 25° C. to 25° C., very particularly preferably from −15° C. to +15° C. The glass transition temperatures indicated relate to values determined by means of DSC measurements in accordance with DIN-EN-ISO 11357-2:2014. In a preferred variant, the SBRs are additionally protected by means of antioxidants against oxidative and photooxidative degradation. Preferred antioxidants are phenolic antioxidants.

If the PUDs used contain hydroxyl groups, these are preferably used in compositions such as primers which contain a crosslinker in the form of the above-described crosslinker component which reacts with hydroxyl groups during curing. The content of hydroxyl groups based on the nonvolatile proportion (1 g/1 h/125° C.) in accordance with DIN EN ISO 3251 of the PUD is preferably below 3.5% by weight, in particular below 2.0% by weight and particularly preferably the range from 0.5 to 1.5% by weight.

Examples of reactive crosslinker components are preferably polyisocyanates, including latently reactive or blocked polyisocyanates, polyaziridines and also polycarbodiimides, melamine crosslinkers such as hexamethlylolmelamine or mixtures of at least two thereof. The crosslinkers can preferably contain hydrophilizing and/or emulsifying constituents and/or be diluted with solvents which assist incorporation into the aqueous dispersions. The amount and functionality of the crosslinkers should, in particular, be matched to the desired properties of the surface coating, in particular under thermal stress, and optionally be determined by simple tests. Furthermore, in selecting the crosslinker, the temperature necessary for reaction of the crosslinker in the surface coating during curing should be matched to the drying and curing process. In general, from 0.5 to 15.0% by weight of crosslinkers based on the solids content of the SBR dispersion are added. Many of the possible crosslinkers reduce the storage life of the composition as coating composition since they react slowly even in the aqueous dispersion. The addition of crosslinkers should therefore be carried out appropriately shortly before, preferably not more than 24 hours before, or preferably not more than 10 hours before, particularly preferably not more than 1 hour before, application. Depending on the degree of hydrophilicity, appropriate methods known per se, such as stirring-in with an appropriate shear force, dispersion or incorporation by means of mixers, should be used for incorporating the crosslinking into the aqueous dispersion.

Particularly preferred crosslinkers are polyisocyanates. Polyisocyanates used are aromatic, araliphatic, aliphatic and cycloaliphatic diisocyanates or polyisocyanates. It is also possible to use mixtures of diisocyanates or polyisocyanates. Examples of suitable diisocyanates or polyisocyanates are butylene diisocyanate, pentamethylene diisocyanate (PDI), hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexypmethanes and mixtures thereof with any isomer content, isocyanatomethyloctane 1,8-diisocyanate, cyclohexylene 1,4-diisocyanate, the isomeric cyclohexanedimethylene diisocyanates, phenylene 1,4-diisocyanate, toluene 2,4- and/or 2,6-diisocyanate, the isomeric xylene diisocyanates, naphthalene 1,5-diisocyanate, diphenylmethane 2,4′- or 4,4′ -diisocyanate, triphenylmethane 4,4′, 4″-triisocyanate or derivatives thereof having a urethane, urea, carbodiimide, acylurea, isocyanurate, allophanate, biuret, oxadiazinetrione, uretdione, iminooxadiazinedione structure and mixtures of at least two thereof. Preference is given to polyisocyanates based on oligomerized and/or derivatized diisocyanates which have been freed of excess diisocyanate by suitable methods, in particular those derived from pentamethylene diisocyanate, hexamethylene diisocyanate, isophorone diisocyanate and the isomeric bis(4,4′-isocyanatocyclohexyl)methanes and also mixtures of at least two thereof.

Preference is given to the oligomeric isocyanurates, uretdiones, allophanates and iminooxadiazinediones of PDI, of HDI, of IPDI and/or of the isomeric bis(4,4′-isocyanatocyclohexyl)methanes and also mixtures thereof. Particular preference is given to the oligomeric isocyanurates, uretdiones and allophanates of PDI and HDI.

Commercially available polyiscoyanates are available under the tradename Desmodur® and Bayhydur® from Covestro AG, DE. Desmodur® N 3300, 3500, 3600, 3900, eco N 7300, Z 4470, and all Bayhydur® grades are particularly useful. Further commercially available polyisocyanates are Tolonate™ and Esaqua™, Vencorex Holding SAS, Basonat®, BASF SE, Wanate®, Wanhua Chemical by and also Duranate®, Asahi Kasei Europe GmbH.

Particular preference is given to mixtures of non-hydrophilized and hydrophilized polyisocyanates and solvents which assist incorporation of the crosslinker into the aqueous primer. Examples of preferred solvents are 1-methoxy-2-propyl acetate, propylene carbonate, propylene glycol diacetate, butyl glycol acetate, dibasic esters, dipropylene glycol dimethyl ether, 3-methoxybutyl acetate, butyl acetate. The ratio of hydrophilized to non-hydrophilized polyisocyanates depends on the shear forces available for incorporation. The less hydrophilized the polyisocyanate which is used, the better the resistances of the cured primer usually are to, in particular, aqueous and other polar media. For this reason, the hydrophilized component should be present in a very small proportion therein. The proportion of the solvent should be selected so that it reduces the viscosity of the crosslinker to preferably below 1000 mPa s, in particular below 500 mPa s, at 23° C. (in accordance with ISO 3219/A.3). The proportion of solvent therefore usually does not exceed 30% by weight of the reactive crosslinker component, based on the total amount of the crosslinker component. When crosslinkers have a low viscosity and/or a very high available shear energy for incorporation, solvents can be dispensed with.

If a polyurethane dispersion having hydroxyl groups is present in the composition of the invention, for example as primer component, the molar amount of the abovementioned polyisocyanate crosslinker to be used should preferably be close to or in the stoichiometric ratio of NCO:OH in the range from 0.8:1 to 2:1, in particular from 0.9:1 to 1.2:1.

In a preferred embodiment of the composition, the same crosslinker which is also used for the later topcoat or clear varnish layer is used as reactive crosslinker component. For example, a polyisocyanurate of HDI diluted with a mixture of butyl acetate and solvent naphtha, for example Desmodur® N 3368 BA/SN from Covestro AG, DE, is frequently used as crosslinker component for solvent-containing two-component polyurethane clear varnishes. This crosslinker can also be used as crosslinker for the composition of the invention by mixing at a high shear energy, e.g. using a static mixer. The mixing ratio of crosslinker to other components of the composition is from 1:2 to 1:20, preferably from 1:5 to 1:12, in particular 1:10.

When a crosslinker component is used, it is preferably used in an amount of from 0.5 to 15.0% by weight, in particular from 2.0 to 13.0% by weight and particularly preferably from 5.0 to 10.0% by weight, based on the nonvolatile proportion (1 g/1 h/125° C.) in accordance with DIN EN ISO 3251. The proportions of PUD and SBR in the composition are decreased accordingly. The weight ratio of PUD to SBR in the nonvolatile proportion of the composition preferably continues to remain in the range from 10:1 to 1:3, preferably in the range from 9:1 to 1:2, based on proportions by weight in the nonvolatile proportion.

In a preferred embodiment, the composition additionally contains at least one electrically conductive pigment. Examples of suitable electrically conductive pigments are metal pigments, conductive carbon blacks, doped pearlescent pigments or conductive barium sulfate.

Particularly well-suited electrically conductive pigments are conductive carbon blacks. The addition of the conductive pigments enables electrostatic spray application to be employed in coating steps following coating with primer, so that the transfer efficiency of the subsequent layers is increased. The composition preferably comprises the electrically conductive pigment in an amount of from 0.01 to 10% by weight, preferably from 0.1 to 8% by weight, particularly preferably from 0.5 to 7% by weight, very particularly preferably from 0.5 to 6% by weight and in particular from 0.5 to 5% by weight, in each case based on the total amount of the composition. Preference is given to conductive carbon blacks and, in particular, pearlescent pigments doped for light color tones of the topcoat layer, in particular products of the Iriotec® 7300 series of Merck KGaA, DE.

The composition preferably comprises additives customary in surface coatings in effective amounts, preferably in each case in a range from 0.1 to 5% by weight, based on the total amount of the composition. Examples of suitable additives are:
organic and/or inorganic pigments, anticorrosion pigments and/or fillers such as calcium sulfate, barium sulfate, silicates such as talc, bentonite or kaolin, silicas, oxides such as aluminum hydroxide or magnesium hydroxide, nanoparticles, organic fillers such as textile fibers, cellulose fibers, polyethylene fibers or wood flour, titanium dioxide, carbon black, iron oxide, zinc phosphate or lead silicate; these additives can also be incorporated into the composition of the invention via pigment pastes;
free radical scavengers;
organic corrosion inhibitors;
catalysts for crosslinking, e.g. inorganic and organic salts and complexes of tin, lead, antimony, bismuth, iron or manganese, preferably organic salts and complexes of bismuth and of tin, in particular bismuth lactate, ethylhexanoate or dimethylolpropionate, dibutyltin oxide or dibutyltin dilaurate;
slip additives;
polymerization inhibitors and light stabilizers;
antifoams;
emulsifiers, in particular nonionic emulsifiers such as alkoxylated alkanols and polyols, phenols and alkylphenols or anionic emulsifiers such as alkali metal salts or ammonium salts of alkanecarboxylic acids, alkanesulfonic acids and sulfonic acids of alkoxylated alkanols and polyols, phenols and alkylphenols;
wetting agents such as siloxanes, fluorine-containing compounds, carboxylic monoesters, phosphoric esters, polyacrylic acids and copolymers thereof or polyurethanes;
bonding agents;
leveling agents;
film-forming auxiliaries such as cellulose derivatives;
flame retardants;
low molecular weight, oligomeric and high molecular weight reactive diluents which can participate in thermal crosslinking, in particular polyols such as tricyclodecanedimethanol, dendritic polyols, hyperbranched polyesters, polyols based on metathesis oligomers or branched alkanes having more than eight carbon atoms in the molecule;
anti-crater additives;
water-miscible or dispersible organic solvents and/or
rheology-controlling additives, crosslinked polymeric microparticles as are disclosed, for example in EP-A-0 008 127; inorganic sheet silicates, preferably smectites, in particular montmorillonites and hectorites, e.g. aluminum-magnesium silicates, sodium-magnesium and sodium-magnesium-fluorine-lithium sheet silicates of the montmorillonite type or inorganic sheet silicates such as aluminum-magnesium silicates, sodium-magnesium and sodium-magnesium-fluorine-lithium sheet silicates of the montmorillonite type; silicas such as aerosils; or synthetic polymers having ionic and/or associatively acting groups, e.g. polyvinyl alcohol, poly (meth)acrylamide, poly(meth)acrylic acid, polyvinylpyrrolidone, styrene-maleic anhydride or ethylene-maleic anhydride copolymers and derivatives thereof or hydrophobically modified polyacrylates; or associative thickeners based on polyurethane.

The composition preferably contains at least one filler, preferably a plurality of fillers.

To produce the composition of the invention, the individual constituents are mixed by means of mixing and dispersion processes customary in the production of surface coatings. Pigments and fillers are preferably mixed to a paste with dispersing additives and possibly proportions of the aqueous polymers of the composition and optionally further additives such as antifoams in high-speed mixers or mills. Mixing with the further constituents of the composition is subsequently carried out. When crosslinkers which would react with constituents of the composition during storage are used as crosslinker component, they are added only appropriately shortly or immediately before application, optionally using two-component apparatuses.

The coating composition is preferably used for coating and/or priming plastics of which the substrates to be coated are made. Examples of suitable plastics for substrates are ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations in accordance with DIN 7728T1). These can also be present in the form of films or as plastics reinforced with glass or carbon fibers. Depending on the plastic used and the quality of the surface to be coated, a cleaning step and/or an activation step can be carried out before application of the composition. Suitable cleaning methods are known from the surface coating of plastic parts and utilize, for example, washing methods using aqueous and/or solvent-containing cleaners, mechanical cleaning by means of brushes and/or pens and also blasting processes, e.g. using carbon dioxide snow. Particular surfaces such as those of PP are not polar enough for coating with aqueous primers, so that activation of the surface by means of known methods such as flaming, corona treatment or plasma treatment, treatment with ozone or fluorination is useful.

Suitable methods for applying the composition of the invention to the plastics substrate are, for example, printing, painting, rolling, pouring, dipping and/or preferably spraying, for example compressed air spraying, airless spraying, high rotation, electrostatic spraying application (ESTA), optionally combined with hot spray application such as hot-air hot spraying.

Suitable layer thicknesses depend on the method of application and are, as dry layer thickness, usually in the range from 5 to 50 μm, preferably from 10 to 30 μm, in particular from 12 to 22 μm.

After application of the composition, water and any further volatile substances such as organic solvents are firstly removed by methods customary in surface coating technology. The removal of water is preferably effected by drying at elevated temperatures, e.g. in the range from 40 to 250° C., preferably from 40 to 100° C., in an oven and with moving and optionally also dehumidified air (convection oven, jet drier) or else thermal radiation (IR, NIR). Furthermore, microwaves can be employed. It is possible to combine a plurality of these drying methods.

The conditions for drying are advantageously selected so that the maximum temperature reached remains below the limit at which the substrate deforms in an uncontrolled manner or suffers other damage.

Immediately afterward, or else only after a relatively long period of storage, the substrate which has been coated/primed with the coating according to the invention can be coated with a further surface coating. The further surface coating can be carried out in one layer using a topcoat or preferably in a plurality of layers using a base coating and clear varnish.

The invention further provides for use of the composition of the invention containing an aqueous polyurethane dispersion (PUD) and a styrene-polybutadiene copolymer dispersion (SBR) for coating substrates, in particular thermoplastic substrates. Preferred substrates are those which were mentioned above in connection with the composition of the invention.

The invention further provides a multilayer structure, in particular a multilayer surface coating structure, containing the abovementioned composition according to the invention.

All features such as properties, constituents and the proportions thereof in the composition also apply to the composition in the multilayer structure. The multilayer structure preferably has at least two layers, of which at least one of the layers comprises the composition of the invention. The multilayer structure has preferably been applied to a substrate which has at least one surface selected from the group consisting of a polymer, a metal, in particular steel, a wood, a ceramic, a glass or a combination of at least two thereof. The surface of the substrate preferably comprises or consists of a polymer. The polymer is preferably selected from the group consisting of polypropylene, polyethylene, polycarbonate, polyamide, polyimide, polystyrene, polyethylene terephthalate, polybutylene terephthalate, polymethyl methacrylate, polyurethane, polyacrylate or mixtures or copolymers of at least two thereof. Preferred substrates are those which have been mentioned above in connection with the composition of the invention.

The number of base coating layers and clear varnish layers and also the topcoat layer to be applied is in each case not limited to one layer. It is also possible to apply two, three, four or more base coating layers or apply multiply alternating base layers and clear layers. The individual layers can in each case be dried completely or only partially dried before the next layer is applied. The layer is also referred to as “wet on wet” application. In the case of final coating with a topcoat, the number of layers is not limited to one.

The composition of the invention is suitable for coating with both aqueous and solvent-containing and even pulverulent surface coatings. Coating with one or two layers of an aqueous base coating is effected, in particular, by electrostatic spray application, intermediate drying to remove the main part of the water and optionally solvent of the base coating layer, subsequent coating with a solvent-containing two-component clear polyurethane varnish and subsequent drying and curing of the surface coating substrate by the abovementioned customary methods for surface coating drying and curing.

Preference is given to plastics in the automobile sector being coated and/or primed with the coating composition of the invention.

The invention further provides automobiles which contain plastics and are coated with the abovementioned coating composition of the invention. In particular, the plastics which have been coated with the composition according to the invention are arranged in the exterior region of the automobile, for example in the form of bumpers, decorative strips, sills, air deflectors, door handles, radiator grilles, antenna housings, linings, coverings or exterior mirror housings. These fixtures can be finally coated in the color of the vehicle or in a contrasting color.

### Experimental Part

The invention will be further illustrated below with the aid of examples.

### Substances Used:

The substances were, unless indicated otherwise, used without purification or pretreatment. Bayhydrol® U 2757, Covestro AG, DE, aliphatic, anionic hydroxy-functional polyurethane dispersion based on a mixture of an aromatic polyester diol and a polycarbonate diol, cosolvent-free. Binder for producing water-dilutable two-component PUR coatings, about 52% strength in water/ N,N-dimethylethanolamine, hydroxyl content about 1.8% (calculated) based on the nonvolatile proportion (1 g/1 h/125° C.) in accordance with DIN EN ISO 3251, specifications as per datasheet issued on Sep. 1, 2015.

Bayhydrol® UH 2606, Covestro AG, DE, aliphatic, polycarbonate-containing anionic polyurethane dispersion, cosolvent-free. Binder for producing water-dilutable coatings for plastic substrates and wood materials, about 35% strength in water, neutralized with N-ethyldiisopropylamine (bound as Salt) in the ratio of about 35:64:1, specifications as per datasheet issued on 09/01/2015.

Desmodur® N 3600, Covestro AG, DE, polyisocyanate based on trimers of hexamethylene diisocyanate, NCO content 23.0% (ISO 11909), viscosity 1200 mPa s at 23° C.(ISO 3219/A.3), specifications as per datasheet issued on Jun. 1, 2017.

Bayhydur® XP 2655, Covestro AG, DE, hydrophilic polyisocyanate based on trimers of hexamethylene diisocyanate, NCO content 20.8% (ISO 11909), viscosity 3500 mPa s at 23° C.(ISO 3219/A.3), specifications as per datasheet issued on Jun. 1, 2017.

Litex® SX 1024, Synthomer Deutschland GmbH, aqueous colloidal dispersion of a styrene-butadiene copolymer having carboxyl groups, containing an anionic emulsifier system, stabilized with an antioxidant. Solids content 50.0%, pH 7,0, viscosity <400 mPas, glass transition temperature −15° C., average particle size 0.15 μm, specifications as per Technical Data Sheet, Revision: 3, Oct. 30, 2014.

Litex® S 7140, Synthomer Deutschland GmbH, aqueous, anionic dispersion of a carboxylated styrene-butadiene copolymer, stabilized with a noncoloring antioxidant. Solids content 51.0%, pH 8.0, viscosity <300 mPas, glass transition temperature 48° C., average particle size 190 nm, specifications as per Technical Data Sheet, Revision: 4, Oct. 30, 2014.

Litex® S 7155, Synthomer Deutschland GmbH, anionic dispersion of carboxylated styrene-butadiene copolymer, stabilized with a noncoloring antioxidant. Solids content 50.0% pH 7.75, viscosity <750 mPas, glass transition temperature −26 ° C., average particle size 195 nm, specifications as per Technical Data Sheet, Revision: 4, Oct. 30, 2014.

Litex® PX 9306, Synthomer Deutschland GmbH, aqueous, anionic, carboxylated dispersion of a styrene-butadiene copolymer. Solids content 50.0%, pH 6,7, viscosity <300 mPas, glass transition temperature 12° C., specifications as per Technical Data Sheet, Revision: 4, Oct. 30, 2014.

Dispex® Ultra FA 4436, BASF SE, DE, dispersant

Surfynol® 104 E, Evonik Resource Efficiency GmbH, DE, nonionic wetting agent, antifoam dispersant

Byk® 348, Byk Chemie GmbH, DE, silicone surfactant for improving wetting of the substrate

R-KB-2, Sachtleben Chemie GmbH, white pigment

Blanc fixe micro, Sachtleben Chemie GmbH, filler

Finntalc® M-15 AW, Mondo Minerals B.V., NL, talc

Bayferrox0 318 M, Lanxess AG, DE, iron oxide pigment

Aerosil® R 972, Evonik Resource Efficiency GmbH, DE, pyrogenic silica

N,N-dimethylethanolamine (DMEA), Aldrich, DE, neutralizing agent

Borchigel® PW 25, OMG Borchers, DE, polyurethane thickener

1-methoxy-2-propyl acetate (MPA), BASF SE, DE, solvent

Hydrobasislack schwarz R 2341, Karl Worwag Farben- und Lackfabrik GmbH&Co KG, DE, black aqueous base coating, in particular being suitable for plastic substrates provided with a primer.

Woeropur Klarlack R 3209, Karl Worwag Farben- und Lackfabrik GmbH&Co KG, DE, solvent-based two-component polyurethane coating consisting of stock coating composition and hardener for coating plastics substrates, in particular for coating over Hydrobasislack R 2341.

### Plastics Substrates:

The following thermoplastics were used in the form of rectangular test plates (having a size of at least 13×18 cm). In addition, a polycarbonate film was used as substrate. All plates and films were wiped with a clean cloth soaked with ethyl acetate before coating.
1. Bayblend® T65 XF: polycarbonate-polyacrylonitrile-polybutadiene-polystyrene copolymer blend [PC/ABS], Covestro AG, DE
2. Pocan T 7323: polybutylene terephthalate-polyethylene terephthalate copolymer blend containing 20% glass fibers [PBT+PET], Lanxess Deutschland GmbH, DE
3. Durethan BKV 30 H2.0 OEF: polyamide 6 containing 30% glass fibers [PA6], Lanxess Deutschland GmbH, DE
4. Durethan BKV 60 H2.0 OEF: polyamide 6 containing 30% glass fibers [PA6], Lanxess Deutschland GmbH, DE
5. Makrofol DE 1-1 CG 000000, polycarbonate film having a layer thickness of 500 p.m

[PC], Covestro AG, DE

### Test Methods:

1. Time taken to run out from a 4 mm DIN cup in accordance with DIN EN ISO 2431:2012
2. Testing of the adhesive strength of a coating on a substrate by means of a cross-cut test using a multiblade tool with handle in accordance with DIN EN ISO 2409:2013 (blade spacing 1 mm only for the primer layer to 2 mm for a multilayer structure of primer, base coating, clear varnish): after carrying out cross-cuts down to the substrate, loose particles were removed using a brush. A “Scotch Pressure Sensitive Tape” adhesive tape from 3M was then firstly rubbed onto the cut lattice pattern by means of a thumb nail and quickly pulled off as vertically as possible in an upward direction from the coating. The damage was evaluated using a magnifying glass and evaluated by comparison with the cut patterns depicted in the standard. GT 0 means that the cut patterns are completely smooth and no pieces have flaked off.
3. Steam jet test in accordance with DIN EN ISO 16925:2014 on plastic parts coated with a primer and a topcoat: the test was carried out by the method A 3.9 using a Sikkens scoring tool and a steam jet instrument from Walther. The parts were conditioned at 23±2° C. and 50±5% atmospheric humidity for at least 16 hours before the test. At characteristic values of KW 0 and KW 1, the test is considered to have been passed; at KW 2, it is considered to have been conditionally passed and at KW 3 to 5 it has not been passed. A lowercase letter (a, b or c) after the characteristic value 1 or 2 serves for a more detailed explanation of the damage pattern as indicated in the standard.

### Surface Coating Formulations:

The following surface coating formulations (table 1) were produced as follows. Comparative example 1[V] corresponded to the starting formulation disclosed by Covestro AG, DE for aqueous, two-component plastic primer PCO-0148-PS (edition Sep. 13, 2016). To produce all of the surface coating formulations of table 1, the binders (part 1) were in each case initially charged and the constituents under part 2 were weighed in, in the order indicated, and mixed with glass beads (2.85 3.45 mm) 1:1 (by volume) and made into a paste using a laboratory shaker Skandex BA-S20 from Lau for 30 minutes. The glass beads were subsequently sieved off. The thickener (part 3) was subsequently introduced slowly into the cooled surface coating while stirring by means of a high-speed stirrer (stirrer disk 5 cm, at 800 rpm) and the mixture was subsequently stirred for a further 5 minutes. The formulated dispersed surface coatings were adjusted by means of deionized water to a running-out time from a 4 mm DIN cup of from 25 to 30 s. Table 1 shows the amount of water necessary for this in each case under part 4. Shortly before application, part 5 was incorporated while stirring with a blade stirrer (5 min, 700 rpm). The running-out time from a 4 mm cup was subsequently determined and the primers were applied within 30 minutes.

TABLE 1
Surface coating formulations for primer (1[V])-
comparison, 2 to 7 - according to the invention)

| | 1[V] | 2 | 3 | 4 | 5 | 6 | 7 |
|---|---|---|---|---|---|---|---|
| Part 1 | | | | | | | |
| Bayhydrol ® U 2757 | 79.1 | 55.1 | 55.1 | 55.1 | 55.1 | 51.5 | 51.6 |
| Bayhydrol ® UH | 124.3 | 86.6 | 86.6 | 86.6 | 86.6 | 153.0 | 76.7 |
| 2606 | | | | | | | |
| Litex ® SX 1024 | — | 60.6 | — | — | — | 53.6 | 107.3 |
| Litex ® S 7140 | — | — | 59.4 | — | — | — | — |
| Litex ® S 7155 | — | — | — | 60.6 | — | — | — |
| Litex ® PX 9306 | — | — | — | — | 60.6 | — | — |
| Part 2 | | | | | | | |
| Dispex ® Ultra FA | 1.6 | 1.6 | 1.6 | 1.6 | 1.6 | 1.9 | 1.9 |
| 4436 | | | | | | | |
| Surfynol ® 104 E | 1.0 | 1.0 | 1.0 | 1.0 | 1.0 | 0.8 | 0.8 |
| Byk ® 348 | 0.7 | 0.7 | 0.7 | 0.7 | 0.7 | 1.2 | 1.2 |
| R-KB-2 | 30.0 | 30.0 | 30.0 | 30.0 | 30.0 | 52.1 | 52.1 |
| Blanc fixe micro | 45.0 | 45.0 | 45.0 | 45.0 | 45.0 | 34.7 | 34.7 |
| Finntalc ® M-15 AW | 15.0 | 15.0 | 15.0 | 15.0 | 15.0 | 17.4 | 17.4 |
| Bayferrox ® 318 M | 1.0 | 1.0 | 1.0 | 1.0 | 1.0 | 1.2 | 1.2 |
| Aerosil ® R 972 | 2.6 | 2.6 | 2.6 | 2.6 | 2.6 | 3.0 | 3.0 |
| DMEA (10% strength | — | — | — | — | — | — | — |
| in water) | | | | | | | |
| Water | 30 | 55 | 40 | 40 | 35 | 30 | 50 |
| Part 3 | | | | | | | |
| Borchigel ® PW 25 | 0.7 | 0.7 | 0.7 | 0.7 | 0.7 | 0.8 | 0.8 |
| Part 4 | | | | | | | |
| Water for setting to | 36.8 | 60.8 | 36.5 | 46.9 | 35.7 | 34.9 | 57.5 |
| 25-30 s running out | | | | | | | |
| time | | | | | | | |
| Part 5 | | | | | | | |
| Desmodur ® N 3600: | 17.3 | 12.1 | 12.1 | 12.1 | 12.1 | 11.3 | 11.3 |
| Bayhydur ® XP 2655 | | | | | | | |
| (70:30) 75% strength | | | | | | | |
| in MPA | | | | | | | |
| Overall total | 385.1 | 427.9 | 387.3 | 398.9 | 382.7 | 448.4 | 467.5 |
| Calculated nonvolatile | 51.2 | 46.1 | 50.9 | 49.4 | 51.5 | 50.9 | 48.8 |
| proportion [%] | | | | | | | |
| Measured running-out | 25 | 26 | 24 | 22 | 24 | 24 | 24 |
| time [s] | | | | | | | |
| Calculated molar ratio | 1.5:1 | 1.5:1 | 1.5:1 | 1.5:1 | 1.5:1 | 1.5:1 | 1.5:1 |
| of NCO:OH | | | | | | | |
| 100 g total parts 1-3 | 4.7 | 2.9 | 3.2 | 3.1 | 3.3 | 2.6 | 2.5 |
| to x g of part 4 | | | | | | | |

Application of Surface Coating To test the adhesive strength before and after storage under hydrolysis conditions of 90° C., 90% relative atmospheric humidity for 72 hours, the primer in the form of the surface coating compositions 1C, 2 to 7 was applied over the full area of the plastics substrates and dried. Half of the area was subsequently covered and the other half was coated with black Hydrobasislack R 2341 and then with Klarlack R 3209. The adhesive strength of the primer and the total structures of primer, base coat and clear varnish was, in each case after aging of the coated plates, 16 hours at 60° C. in a convection oven and 8 hours at room temperature, tested by means of the cross-cut test (1 mm blade spacing for the primer, 2 mm spacing for the total structures) both before and after storing under hydrolysis conditions.

For testing of the adhesive strength by the steam jet test, the plastics substrates of Bayblend® were in each case coated over their full area firstly with the primers and then with base coating and clear varnish. Testing was in each case carried out after aging of the coated plates for 16 hours and 60° C. in a convection oven and subsequent conditioning in a standard atmosphere.

In both test series, the application of the primer was carried out using a flow cup gun Satajet RP, 1.3 mm, air pressure 2.1 bar in 1 cross pass in order to produce a layer thickness (dry) of 20-25 gm. After application, the primer was dried for 10 minutes at room temperature, for 30 minutes at 80° C. in a convection oven and stored for 16 hours at room temperature.

Application of the base coating was carried out using a flow cup gun Satajet HVLP, 1.2 mm, air pressure 2.1 bar in one cross pass in order to produce a layer thickness (dry) of 9-12 gm. The base coating was dried for 10 minutes at room temperature, for 30 minutes at 80° C. in a convection oven and stored for 3 hours at room temperature. Application of the clear varnish was carried out after mixing stock coating composition and hardener according to the manufacturer's instructions by means of a flow cup gun Satajet HVLP, 1.2 mm, air pressure 2.1 bar in 1 cross pass in order to produce a layer thickness (dry) of 25-32 gm. The clear varnish was dried for 10 minutes at room temperature and for 45 minutes at 80° C. in a convection oven. It was subsequently stored at 60° C. for 16 hours.

Results of cross-cut test before and after storage under hydrolysis conditions All primers (1[V], 2 7) and all total structures composed of primer (1[V], 2 7), base coating and clear varnish displayed excellent initial adhesion (all GT 0) and unaltered adhesive strength after storage under hydrolysis conditions (all GT 0) and after regeneration (all GT 0) on all plastics substrates tested (Bayblend®, Pocan®, both Durethan® grades and Makrofol®).

This result shows that, despite a proportion of cheaper binders, the primer formulations according to the invention are just as suitable for producing primers having excellent adhesive strength as the comparable example (1[V]) which contains only binders based on polyurethanes.

### Results of Steam Let Test

TABLE 2
Results of the steam jet test on Bayblend ® plates coated with primer, base
coating and clear varnish (primer 1[V] - comparison 2 to 7 - according to the invention).

| | 1[V] | 2 | 3 | 4 | 5 | 6 | 7 |
|---|---|---|---|---|---|---|---|
| Characteristic values | 2a | 2a | 2a | 2a | 1a | 1c | 1c |
| Evaluation | Conditional | Conditional | Conditional | Conditional | OK | OK | OK |

The results of the steam jet test show that the surface-coated plastic plates with the primers according to the invention have at least the same resistance after stressing with the steam jet as the comparative example (1[V]) which contains only binders based on polyurethanes.

1. A composition for coating substrates, comprising at least one optionally hydroxy-functional, anionic or nonionic polyurethane dispersion and at least one anionic styrene-butadiene copolymer dispersion.

2. The composition as claimed in claim 1, wherein a weight ratio of the at least one polyurethane dispersion to the anionic styrene-polybutadiene copolymer dispersion is in a range from 10:1 to 1:3, based on a nonvolatile proportion of the composition.

3. The composition as claimed in claim 1, wherein the composition comprises the at least one polyurethane dispersion in an amount of from 33 to 90% by weight, based on a nonvolatile proportion of the composition.

4. The composition as claimed in claim 1, wherein the composition comprises the at least one anionic styrene-polybutadiene copolymer dispersion in an amount of from 9 to 67% by weight, based on a nonvolatile proportion of the composition.

5. The composition as claimed in claim 1, wherein the composition comprises at least one reactive crosslinker component.

6. The composition as claimed in claim 5, wherein the at least one reactive crosslinker component comprises a polyisocyanate having a functionality in a range from 1.5 to 6.

7. The composition as claimed in claim 1, wherein the polyurethane dispersion comprises a polyurethane obtained from a reaction of reaction mixture comprising:
(A) at least one diol and/or polyol component,
(B) at least one polyisocyanate component,
(C) at least one hydrophilizing component having at least one hydrophilizing group,
(D) optionally mono-, di-, or tri-amino-functional compounds, or a combination thereof and/or hydroxyamino-functional compounds, and
(E) optionally at least one additional isocyanate-reactive compound.

8. The composition as claimed in claim 7, wherein the polyol component (A) has a number average molecular weight Mn in a range from 62 to 18 000 g/mol.

9. The composition as claimed in claim 7, wherein the at least one polyisocyanate component (B) comprises tetramethylene diisocyanate, pentamethylene diisocyanate, hexamethylene diisocyanate, dodecamethylene diisocyanate, 1,4-diisocyanatocyclohexane, 1-isocyanato-3, 3, 5-trim ethyl-5-isocyanato-methylcyclohexane, 4,4′-diisocyanato-dicyclohexylmethane, bis(4-isocyanatocyclohexyl)methane, 2,2-bis(4-isocyanatocyclohexyl)propane, 1,4-diisocyanatobenzene, 2,4-diisocyanatotoluene, 2,6-diisocyanatotoluene, 4,4′-diisocyanatodiphenylmethane, 2,2′-diisocyanatodiphenylmethane, and-2,4′-diisocyanatodiphenylmethane, tetramethyl-xylylene diisocyanate, p-xylylene diisocyanate, p-isopropylidene diisocyanate or a mixture of at least two of these compounds.

10. The composition as claimed in claim 7, wherein the hydrophilizing group of the hydrophilizing component (C) comprises a sulfonate group, a carboxylate group, or a combination thereof.

11. The composition as claimed in claim 7, wherein the mono-, di-, or tri-amino-functional compounds and/or hydroxyamino-functional compounds (D) comprise aliphatic, alicyclic primary, secondary monoamines, or a combination thereof.

12. The composition as claimed in claim 7, wherein the composition comprises at least one electrically conductive pigment.

13. A method of coating a substrate, comprising applying the composition as claimed in claim 1 to at least of portion of the substrate.

14. A multilayer structure, comprising at least the composition as claimed in claim 1.

15. An object, comprising a substrate coated with the composition as claimed in claim 1.

16. The composition as claimed in claim 5, wherein the at least one reactive crosslinker component comprises a polyisocyanate in an amount of from 0.01 to 5% by weight, based on a nonvolatile proportion of the composition.

17. The composition as claimed in clam 6, wherein the at least one reactive crosslinker component comprises the polyisocyanate in an amount of from 30 to 100% by weight, based on a total mass of the at least one reactive crosslinker component.

18. The composition as claimed in claim 8, wherein the polyol component (A) comprises a polyether polyol, a polyester polyol, a polycarbonate polyol, a polylactone polyol, a polyamide polyol, or mixtures of at least two thereof.

19. The composition as claimed in claim 12, wherein the composition comprises the at least one electrically conductive pigment in an amount of from 0.01 to 10% by weight, based on a total weight of the composition.
